(19) United States
(12) Patent Application Publication
(10) Pub. No.: US 2011/0260611 A1
(43) Pub. Date: Oct. 27, 2011

(54) SHORT ARC TYPE DISCHARE LAMP

(75) Inventors: Yoshio KAGEBAYASHI, Himeji-shi (JP); Takeo MATSUSHIMA, Himeji-shi (JP)

(73) Assignee: USHIO DENKI KABUSHIKI KAISHA, Tokyo (JP)

(21) Appl. No.: 13/082,597

(22) Filed: Apr. 8, 2011

(30) Foreign Application Priority Data
Apr. 23, 2010 (JP) 2010-099641

(51) Int. Cl. H01J 1/42; H01J 61/30

(52) U.S. Cl. 313/630; 313/634

(57) ABSTRACT

In a short arc type discharge lamp wherein a cathode and an anode are arranged oppositely to each other in an interior of a light emitting tube, said cathode having a portion with a decreasing diameter at a tip end thereof, and an emitter material buried in said cathode, such that said emitter material has an exposed portion being exposed in said cathode portion with a decreasing diameter, a distance in a radial direction of a center of said cathode from a periphery of the exposed portion of said emitter material varies in a circumferential direction, thus enabling the same electron radiation function as hitherto while reducing the use level of the emitter material.

### BACKGROUND OF THE INVENTION

1. Field of Invention

The present invention relates to short arc type discharge lamps wherein an emitter material is embedded in the cathode, and relates specifically to short arc type discharge lamps used as exposure light sources utilized in the field of producing semiconductors or liquid crystals etc. or as projector light sources of film projectors or for the digital cinema etc.

2. Description of Related Art

Short arc type discharge lamps containing mercury have a short distance between the tip ends of a pair of electrodes arranged oppositely to each other in a light emitting tube and are close to point light sources. Therefore, they are used as light sources of exposure devices with a high focusing efficiency by means of a combination with an optical system. Short arc type discharge lamps containing xenon are used as light sources of visible light in projectors etc. In recent years, they are also used as light sources for the digital cinema.

In JP 2009-537961 A and corresponding US 2009/0121634 A1, the configuration of a known short arc type discharge lamp and the configuration of the cathode thereof are disclosed. FIG. 5 is a schematical view showing the overall configuration of this short arc type discharge lamp. The short arc type discharge lamp 1 has a light emitting tube 10 made from, for example, quartz glass, and said light emitting tube 10 is provided with an approximately spherical light emitting part 11 and with sealing portions 12, 12 at both ends thereof. In the discharge space S formed in the interior of the light emitting part 11 a light emitting substance such as mercury, xenon and the like is enclosed and a pair of electrodes consisting of a cathode 20 and an anode 30 made from, for example, tungsten and the like is arranged in opposition to each other.

As to the configuration of the cathode of the short arc type discharge lamp with the above-mentioned configuration, in the same document a configuration is shown wherein an emitter material is buried in the tip end of the cathode made from tungsten. This configuration is shown in FIG. 6. An emitter material 21 is buried in the tip end of the cathode 20. At the tip end part of this cathode 20 a tapered portion 22 is formed, the diameter of which being designed such that it decreases gradually towards the tip end side. Said emitter material 21 is exposed at the tapered portion 22 and forms an exposed portion 23. The tip end part 24 of the cathode 20 and the emitter material 21 is designed as a flat face, and the axial centers of said emitter material 21 and the cathode 20 coincide.

Now, for the above-mentioned emitter material 21 generally thorium or thorium oxide is used, or a rare earth oxide such as lanthanum oxide or cerium oxide or a rare earth boride such as lanthanum boride is used. As, usually, in a lamp with a configuration wherein such an emitter material is buried in the cathode an arc A is formed at the time of lighting in a region 23 where the tip end of the emitter material 21 is exposed, it is necessary with lamps wherein the input power is rendered large in order to increase the light quantity to implement the emitter material with a large diameter and to enlarge the exposure region thereof to render the arc large. But an enlargement of the emitter material is not preferred from the aspect of savings in the scarce resources of thorium and rare earth elements. Moreover, when thorium is used for the emitter material, the handling of thorium being a radioactive material is restricted by legal regulations, while when a rare earth element is used as a substitute emitter instead of thorium, there is the problem that the evaporation of the emitter will intensify with the enlargement because the vapor pressure of said rare earth element is higher in comparison to thorium, and a clouding of the light emitting tube can easily occur. Thus, there are various restrictions with regard to the enlargement of the emitter material to comply with a high input power to the lamp, and the implementation thereof is difficult.

Recently, there is a demand for lamps wherein the input power is variable in the same lamp to change the light quantity in accordance with the object to be irradiated. If the size of the emitter material in such a lamp with variable input is determined in accordance with the lighting with a low input, there is the problem that the arc is not sufficiently expanded at the cathode tip end and the current density becomes excessive and the cathode tip end melts at the time of lighting with a high input. If, on the other hand, the size of the emitter material is implemented in accordance with the lighting with a high input, an unnecessary large usage of the emitter material occurs when lighting with a low input, which cannot be said to be preferable from the above-mentioned aspect of savings in the resources.

It is therefore the object of the invention to overcome the problems of the prior art. In more detail, in view of the above-mentioned problems of the state of the art, the problem to be solved by this invention is to provide a short arc type discharge lamp having a cathode configuration wherein an emitter material is buried in the tip end, by means of which the same arc forming abilities as hitherto can be provided also with a restriction in the use level of the emitter material or an implementation with an even higher input can be achieved also with the same use level of the emitter material as hitherto.

### SUMMARY OF THE INVENTION

To solve the above-mentioned problem, the short arc type discharge lamp according to this invention is characterized in that the cathode has a portion with a decreasing diameter at the tip end, the emitter material has an exposed portion being exposed in said portion with a decreasing diameter, and the distance in the radial direction from the cathode center to the periphery of the exposed portion of said emitter material varies in the circumferential direction.

In a further aspect, the emitter material is cylindrical and the central axis thereof is eccentric with regard to the central axis of the cathode.

As, according to the short arc type discharge lamp of this invention, the distance of the periphery of the exposed portion of the emitter material in the portion with the decreasing diameter varies in the circumferential direction, the temperature in parts being exposed at positions with a short distance in the radial direction becomes high because of the proximity to the cathode tip end and the diffusion effect is stimulated, so that said emitter material is widely surface-distributed up to positions where no emitter material is present. Thus the same function as if emitter material were buried as far as these said distribution positions is obtained and the arc can be provided with a large extension. By means of this, there is the result that a higher electron radiation function is obtained although the use level of the emitter material is the same as that of known emitter materials with a cylindrical shape. With other words, there is the result that it is possible to obtain the same size and shape of the arc with a smaller emitter use level than hitherto.

### BRIEF DESCRIPTION OF THE DRAWINGS

FIGS. 1(a) and 1(b) are a top view and a sectional view, respectively, of a cathode of a first embodiment according to the present invention.

FIGS. 2(a) and 2(b) are a side view and a top view of the cathode, respectively, showing the effects of the first embodiment.

FIGS. 3(a) to 3(c) are top views of cathodes of a second to fourth embodiment.

FIG. 4 is an explanation of the effects of the fourth embodiment.

FIG. 5 is an overall view of a known short arc type discharge lamp.

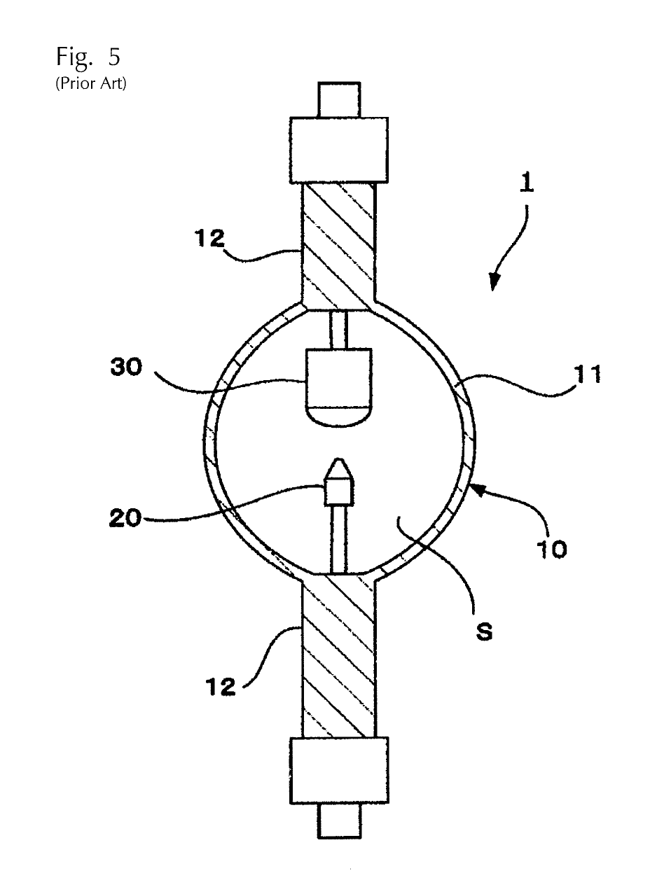

FIG. 6 is a sectional view showing a known configuration of a cathode.

### DETAILED DESCRIPTION OF THE INVENTION

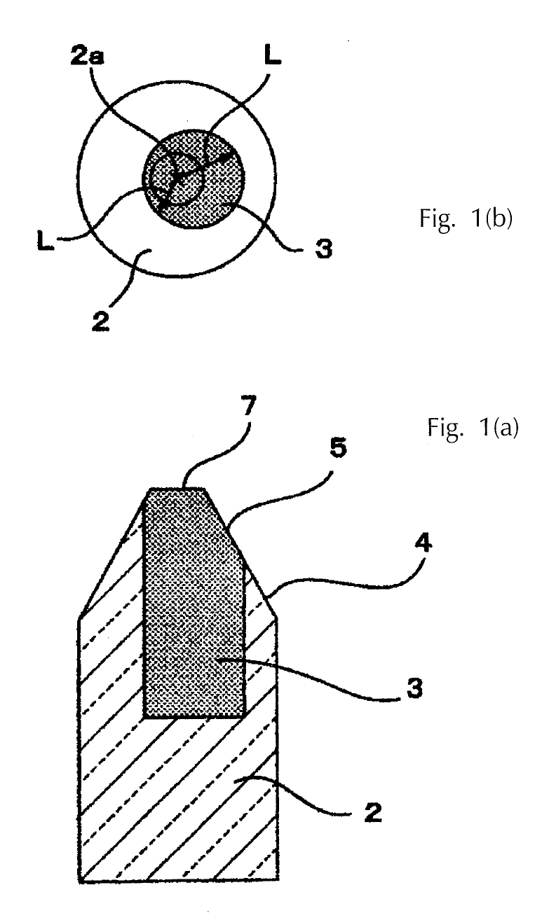

FIG. 1 is an explanatory view of a first embodiment, wherein FIG. 1(a) is a sectional view and FIG. 1(b) is a top view. In the drawing, a cylindrical emitter material 3 is buried in the tip end of a cathode 2. At the tip end of the cathode 2, a tapered portion 4 with a decreasing diameter is formed wherein the diameter decreases towards the tip end side. Said emitter material 3 is exposed in said portion 4 with a decreasing diameter. Further, as also becomes clear from FIG. 1(b), said emitter material 3 is configured such that the central axis thereof is eccentric with regard to the central axis of the cathode 2. Therefore, the length L in the radial direction from the central axis 2a of the cathode 2 to the periphery 6 of the exposed portion 5 of the emitter material 3 varies in the circumferential direction.

The portion 4 with a decreasing diameter of the cathode is taper-shaped, but as it is sufficient that the diameter becomes smaller towards the tip end side, not only a linear decrease but also a decrease having roundness on a circular arc is possible. Further, in the drawing, the tip end part 7 is shown as a flat face, but the shape thereof may not only be flat but may also have the shape of a circular arc.

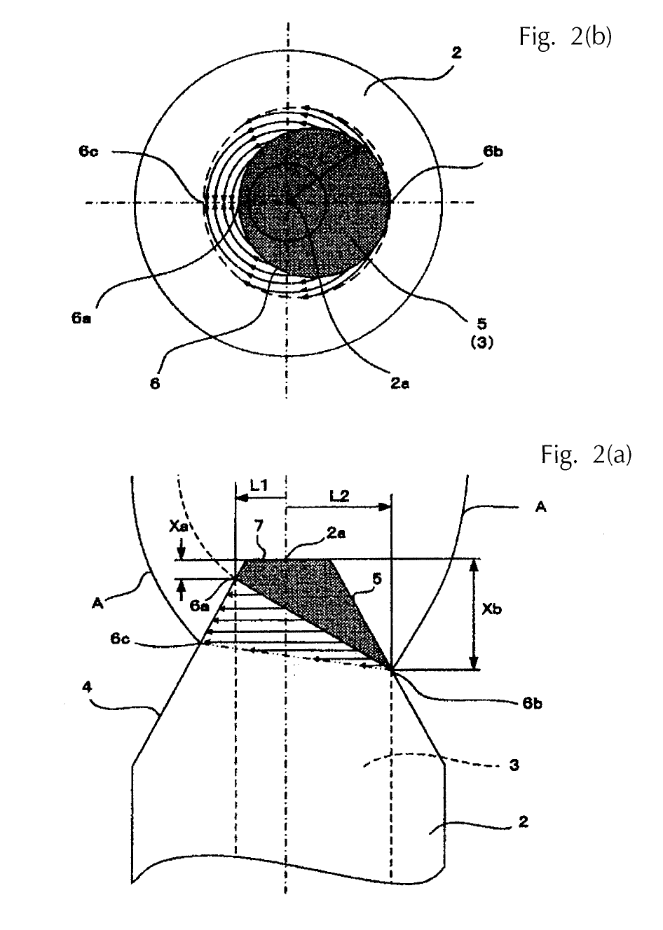

The effects of this embodiment are explained by means of FIGS. 2(a) and 2(b). FIG. 2(a) is a side view of the cathode while FIG. 2(b) is a top view. Because, as is shown in FIG. 2(a), a cylindrical emitter material 3 is buried eccentrically with regard to the cathode 2, the boundary region of the periphery 6 of the exposed portion 5 in the portion 4 with a decreasing diameter is exposed with an approximately linear inclination. That is, the distance Xa from the cathode tip end part 7 is shortest in the part 6a in which the distance L from the central axis 2a of the cathode to the periphery 6 of the exposed portion 5 has the shortest value L1 while the distance Xb from the tip end of the cathode 2 is longest in the part 6b with the longest length L2. The temperature of the cathode 2 is highest at the tip end part 7 and reaches about 3100 K, and the temperature decreases towards the sealing portion side. The temperature gradient of the tip end region is steep and amounts up to 700 K/mm.

The emitter having emerged at the cathode surface because of grain boundary diffusion surface-diffuses towards the low concentration by means of a concentration-diffusion, but as the speed of the diffusion of the emitter becomes faster the higher the temperature is, the emitter is supplied with an increasing speed towards the cathode tip end part 7. Emitter having moved towards the sealing portion side slows down, stops and changes its orientation to the direction having a higher temperature and a lower concentration so that eventually the emitter moves towards the cathode tip end part 7.

At the beginning of the lighting, the emitter is present at the cathode tip end part 7 in a sufficient amount, but because the emitter evaporates and scatters and thus decreases, a condition with a low emitter concentration is maintained from a time after several ten hours to hundred hours of lighting and the emitter is supplied continuously to the cathode tip end part 7. Now, the emitter surface-diffuses from the exposed portion 5 to the cathode tip end part 7, but because it also diffuses while spreading in the circumferential direction, which also contributes to the fact that the emitter concentration is low, it diffuses anywhere at the surface of the main body of the cathode 2. Therefore, an emitter film occurs also in parts where no emitter material 3 is exposed, which has an effect such as if emitter material were buried also in these parts, and the arc expands. As a result, the emitter diffusing from the emitter material 3 to the surface of the portion 4 with a decreasing diameter of the cathode 2 diffuses to the cathode tip end part 7 not only in the exposed portion 5 but also from areas being far from the tip end of the exposed portion 5 while passing over the surface of the main body of the cathode 2. Therefore, the emitter spreads in a region shown by the dotted line, as is shown in FIG. 2(b). Thus, an electron radiation function such as if emitter material were buried in the region shown by the dotted line is provided. That is, at the beginning of the lighting an arc such as shown by the dotted line is formed, but when the cathode temperature increases because of the lighting and the diffusion of the emitter is stimulated, a formation of an arc A shown by the solid line occurs.

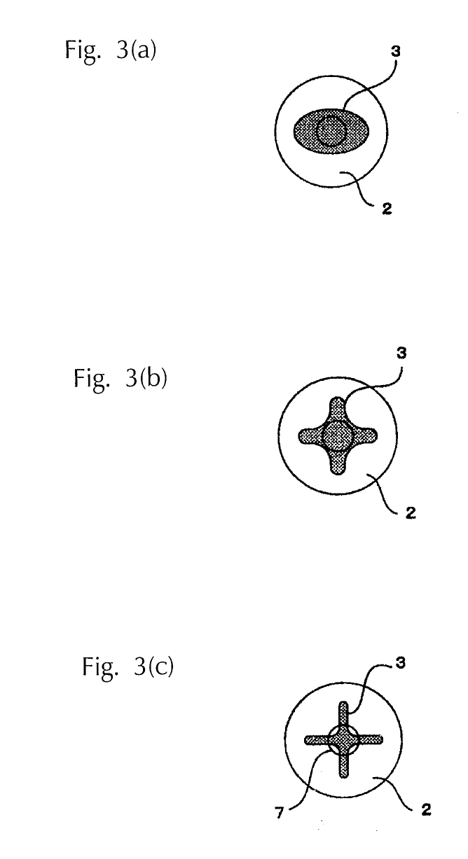

FIGS. 3(a) to 3(c) are top views of a second to fourth embodiment wherein the shapes of the emitter materials differ. FIG. 3(a) is an example wherein the cross-sectional area of the emitter material 3 is elliptic, FIG. 3(b) is an example with a starfish-like cross-sectional area, and FIG. 3(c) is an example with an even narrower starfish-like or cross-like shape. The emitter material 3 is not exposed at the whole surface of the cathode tip end part 7.

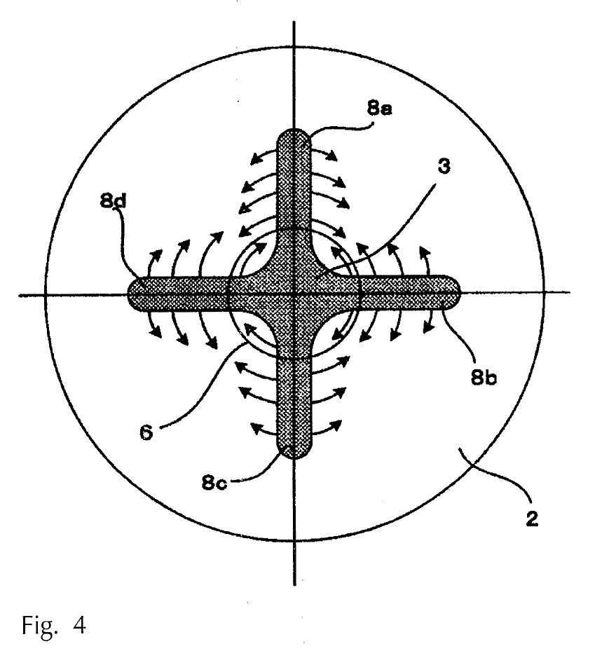

In these embodiments examples are shown wherein the central axis of the emitter material 3 coincides with the central axis of the cathode 2, but configurations wherein these axes do not coincide are also possible. Among these embodiments, the condition of the diffusion of the emitter from the emitter material 3 in the fourth embodiment is shown in FIG. 4. Also in this example there is the effect that the emitter material 3 diffuses from the exposed portions of the branch areas 8a, 8b, 8c, 8d to areas without exposure of the emitter material, and the arc formed thereby expands.

To confirm the results of the present invention, lamps having various kinds of cathode configurations were prepared and tested. First, for the cathode of the state of the art, a cathode with an outer diameter of 15 mm and an emitter material with a diameter of 3 mm containing 2 wt % of highly forged high-density thorium oxide was prepared. Next, a similar thoriated tungsten rod (emitter material) was surrounded in a square-shape by tungsten powder while the center of the thoriated tungsten rod and the center of the square-shaped tungsten powder block were positioned offset. Afterwards, the thoriated tungsten rod was buried integrally in the outer tungsten material by means of compressing with a high pressure and sintering. The surface was grinded and finished to a cathode with an outer diameter of 15 mm, and a cathode with a diameter of the emitter material of 3 mm wherein the central axis of the cathode and the central axis of the emitter material were offset for not more than 0.5 mm was prepared (FIG. 1).

Similarly, a cathode with an outer diameter of 15 mm wherein an emitter material with an approximately elliptical cross-sectional area (long axis 3.2 mm, short axis 2.8 mm) was buried in the center was prepared by surrounding a thoriated tungsten rod rectangularly with tungsten powder (FIG. 3(a)). Then, tungsten powder containing 2 wt % of thorium oxide was sintered to a square-shape. This sintered thoriated tungsten rod (emitter material) was surrounded in a square-shape with tungsten powder while the angles of the sintered thoriated tungsten rod and the square-shaped tungsten powder block were positioned with an offset of 45°. Afterwards, the thoriated tungsten rod was buried integrally in the outer tungsten material by means of compressing with a high pressure and sintering. Thus, a cathode with an emitter material having a starfish-like cross-shape such as in FIG. 3(b) was prepared. A cathode such as in FIG. 3(c) was prepared similarly to that of FIG. 3(b). The cross-sectional areas of the emitter material in the above mentioned cathodes 2 to 5 were designed such that they amounted to the same value as that of the emitter material of the above mentioned cathode 1. These cathodes were cut such that a tip end diameter of 1.5 mm and a tip end angle of 60° were obtained, and short arc type discharge lamps wherein these cathodes were mounted were prepared.

These lamps were lighted with a lamp input of 8 kW, and the melting condition of the cathode tip ends after lighting for 500 hours was examined. The results are shown in the following table 1.

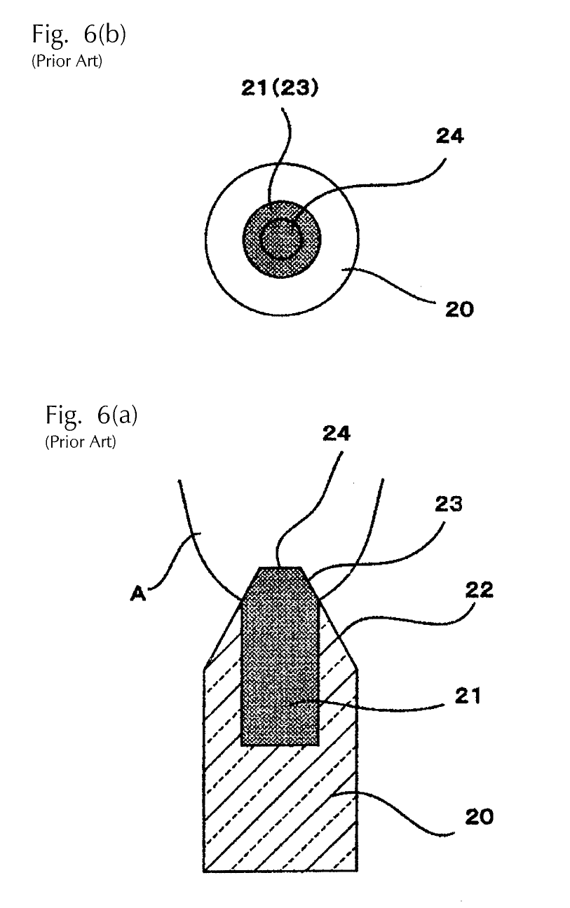

TABLE 1

| cathode | melting of cathode tip end |
|---|---|
| state of the art (FIG. 6) | present |
| present invention (FIG. 1) | none |
| present invention (FIG. 3(a)) | none |
| present invention (FIG. 3(b)) | none |
| present invention (FIG. 3(c)) | none |

As mentioned above, there is a melting of the tip end part in case of the cathode 1 of the state of the art while no melting was observed for the other cathodes 2 to 5 of the present invention.

Now, the above results will be contemplated. When the lamp input is increased, mainly the lamp current increases because the lamp voltage is determined by the gas type/the gas density and the electrode spacing. In the case of the known cathode 20 shown in FIG. 6 it is thought that a sufficient emitter coating is achieved because the emitter material 23 is exposed at the cathode tip end surface, but at the more rearward surface of the cathode where no emitter material is exposed the emitter hardly diffuses towards the sealing portion side because of the above-mentioned reasons, and therefore the arc does not expand, the current density at the cathode tip end part becomes high and the cathode tip end part 26 reaches a high temperature and melts.

Then, in the case of the centers of the emitter material 3 and the cathode 2 being offset (FIG. 1), the emitter diffuses from the region 5 in which the emitter material 3 is exposed in the direction of the cathode tip end, but because the emitter diffuses while also spreading in the direction of the outer circumference, it diffuses also at surfaces of the cathode main body, at which no emitter material 3 is exposed. As, therefore, especially in the region 6a in which the distance to the periphery 6 of the exposed portion 5 is short and the distance from the cathode tip end part 7 is short the emitter diffuses such that it passes from the region 6b in which the distance to the periphery 6 of the exposed portion 5 is long and the distance from the cathode tip end part 7 is long via the surface of the main body of the cathode 2, the emitter spreads such that a coverage up to the region 6c is implemented, and the electrode radiation function spreads as if even there emitter material 3 were buried. As also the arc expands in connection therewith, there is only a relatively small increase of the current density at the cathode tip end part 7, a temperature increase of said cathode tip end part 7 is suppressed and there is no melting.

Also in the case of the emitter material 3 having a flat elliptic shape (FIG. 3(a)) the emitter diffuses from the part of the long axis of the ellipse to the part of the short axis of the ellipse via the surface of the main body of the cathode 2 in the circumferential direction, because of which a spreading of the emitter including the part of the long axis results and the arc can expand in connection therewith. Because there is only a relatively small increase of the current density at the cathode tip end part 7 the temperature increase of the cathode tip end part is suppressed and there is no melting. Similarly, in the cases of FIGS. 3(b) and (c) the emitter diffuses in the lateral direction because of which the arc can expand.

Because, as was explained above, the short arc type discharge lamp according to the present invention is configured such that the emitter material buried in the cathode tip end is exposed in the portion with a decreasing diameter and the distance in the radial direction from the cathode center to the periphery of the exposed portion of said emitter material varies in the circumferential direction, there is a diffusion in the circumferential direction of the emitter material from the part in which the distance to the periphery of the exposed portion is long, and the emitter surface-diffuses in the part of the main body of the cathode where no emitter material is exposed and reaches the area in which the distance from the exposure of the emitter material is long, that is, the arc expands such as if emitter material were buried up to the position of said diffusion. Therefore, a larger arc can be formed also with the same use level of the emitter material as hitherto, there is no melting of the cathode tip end and the input to the lamp can be rendered high. As, in other words, an arc with the same size can be achieved with a smaller emitter use level than hitherto, there is a major contribution to the savings in resources.

What is claimed is:

1. A short arc type discharge lamp wherein a cathode and an anode are arranged oppositely to each other in an interior of a light emitting tube, said cathode having a portion with a decreasing diameter at a tip end thereof, and an emitter material buried in said cathode, such that said emitter material has an exposed portion in said cathode portion with a decreasing diameter,
wherein a distance in a radial direction of a center of said cathode from a periphery of the exposed portion of said emitter material varies in a circumferential direction.

2. The short arc type discharge lamp according to claim 1, wherein said emitter material is cylindrical and a central axis thereof is eccentric with regard to a central axis of the cathode.

3. The short arc type discharge lamp according to claim 1, wherein said emitter material is selected from one of thorium, thorium oxide, a rare earth metal, a rare earth oxide and a rare earth boride.

4. A short arc type discharge lamp according to claim 2, wherein said emitter material is selected from one of thorium, thorium oxide, a rare earth metal, a rare earth oxide and a rare earth boride.

5. The short arc type discharge lamp according to claim 1, wherein said emitter material has one of an elliptical, a cross-like and a starfish-like cross-sectional area.

6. The short arc type discharge lamp according to claim 3, wherein said emitter material has one of an elliptical, a cross-like and a starfish-like cross-sectional area.
